(19) United States
(12) Patent Application Publication
(10) Pub. No.: US 2020/0140763 A1
(43) Pub. Date: May 7, 2020

(54) PROCESS FOR FLUID CATALYTIC CRACKING OF A LIGHT TIGHT OIL IN CO-TREATMENT WITH A CONVENTIONAL FCC FEEDSTOCK

(71) Applicant: IFP Energies nouvelles, Rueil-Malmaison Cedex (FR)

(72) Inventors: Heloise DREUX, Rueil-Malmaison Cedex (FR); Pascal ETIENNE, Rueil-Malmaison Cedex (FR); Ludovic RAYNAL, Rueil-Malmaison Cedex (FR)

(73) Assignee: IFP Energies nouvelles, Rueil-Malmaison Cedex (FR)

(21) Appl. No.: 16/671,771

(22) Filed: Nov. 1, 2019

(30) Foreign Application Priority Data
Nov. 5, 2018 (FR) 18/71.365

(51) Int. Cl. C10G 11/00; B01J 29/08; B01J 21/04; B01J 21/08; B01J 21/12

(52) U.S. Cl. CPC C10G 11/00; B01J 29/084; B01J 21/04; B01J 21/08; B01J 21/12; C10G 2300/205; C10G 2300/1074; C10G 2300/1077; C10G 2300/107; C10G 2300/308; C10G 2300/202; C10G 2300/104

(57) ABSTRACT

The present invention relates to a process for fluid catalytic cracking of a feedstock comprising a light tight oil and at least one conventional feedstock in order to produce an effluent, in which the feedstock has a content of light tight oil so that the density of the feedstock is between 0.84 and 0.91.

### TECHNICAL FIELD

The invention relates to the field of fluid catalytic cracking (FCC) for the production of gasoline (GLN) with a high yield and high octane number.

The production of tight oil or light tight oil (LTO) has greatly increased in recent years, notably in the United States. The current production of light tight oil in the US represents 24% of their crude oil demand. Light tight oils are generally light, paraffinic feedstocks containing metals different from those present in conventional crudes. The current refineries are for the most part sized to treat heavy crudes. The higher yields of naphtha and of distillate of the light tight oils may bottleneck the atmospheric distillation and therefore limit the amount of crude treated. It is therefore necessary to find alternative means of treating light tight oils.

### PRIOR ART

A first document “Processing Tight Oils in FCC: Issues, Opportunities and Flexible Catalytic Solutions” published in 2014 by “Grace Catalysts Technologies Catalagram®” in No. 114 of the journal “Catalagram® A Catalysts Technologies Publication”, describes tests on a small pilot plant (ACE™) for cracking a feedstock containing 100% of light tight oil of “Bakken crude” type which they compared with a 100% vacuum gas oil (VGO) feedstock. It is pointed out in Table VI of the first document that the cracking of a 100% light tight oil feedstock reduces the yields of dry gas, liquefied petroleum gas (LPG), light cycle oil (LCO), bottoms fractions and coke; and increases the yields of gasoline relative to a 100% vacuum gas oil feedstock. On the other hand, the gasoline obtained has a much lower research octane number (RON). Tests on a larger pilot plant (DCR™) lead to the same conclusions.

A second document “Novel Propylene Production Route: Utilizing Hydrotreated Shale Oil as Feedstock via Two-Stage Riser Catalytic Cracking” published in 2015 by “China University of Petroleum and Petrochina” in No. 29, pages 7190-7195 of the journal “Energy Fuels”, describes tests for cracking a conventional feedstock B comprising 70% by weight of vacuum gas oil and 30% by weight of vacuum residue (VR), and a feedstock C comprising 70% by weight of hydrotreated (HDT) light tight oil and 30% by weight of vacuum residue.

Patent application WO 2017/105871 A1 describes a process for catalytic cracking of an atmospheric residue (ATR), derived from light tight oil. According to the patent application, due to a low content of metals, sulfur and coke precursors, an atmospheric residue (343 or 371° C.⁺ fraction) derived from a light tight oil with at least 20% by weight of 566° C.⁺ may be a suitable feedstock for an FCC process without needing to send it to a vacuum distillation.

Patent CN 102286291 B describes a process for catalytic cracking of light tight oil that comprises a step of catalytic cracking of light tight oil and of unconverted oil in a catalytic cracking reactor. The reactor comprises two zones. The conventional feedstock of the FCC process is brought into contact with a fresh catalyst in a first reaction zone. The products obtained are sent to a second reaction zone as a mixture with the light tight oil.

### SUMMARY

Within the context described above, a first object of the present invention is to overcome the problems of the prior art by sending a light tight oil (e.g. directly) to an FCC process (e.g. without prior separation and/or without prior (hydro)treatment of a crude light tight oil). Indeed it has been found that the co-treatment of light tight oils with a heavier feedstock (e.g. conventional FCC feedstock) makes it possible both to obtain overall a main feedstock that is moderately heavy and therefore easier to treat in an FCC process and to obtain gasolines that have higher RON values.

According to a first aspect, the aforementioned objects, and also other advantages, are obtained by an FCC process for a feedstock (i.e., main feedstock or inlet feedstock of the FCC system) comprising a light tight oil and at least one conventional feedstock for producing an effluent (e.g. comprising a gasoline fraction with a high yield and high octane number), in which the feedstock has a content of light tight oil so that the density of the feedstock is between 0.84 and 0.91.

According to one or more embodiments, the conventional feedstock comprises an oil selected from the group consisting of a vacuum gas oil, an atmospheric residue, a coker gas oil, a vacuum residue and a recycle stream from a hydrocracking step.

According to one or more embodiments, the feedstock has a content of light tight oil so that the density of the feedstock is between 0.860 and 0.892.

According to one or more embodiments, the feedstock has a content of light tight oil so that the density of the feedstock is between 0.866 and 0.886.

According to one or more embodiments, the light tight oil comprises at least one of the following features:

density between 0.65 and 0.9;

C5-220° C. content being greater than 15% by weight and preferably greater than 20% by weight relative to the total weight of the light tight oil;

sulfur content of less than 0.5% by weight relative to the total weight of the light tight oil; metal content between 0 and 500 ppm relative to the total weight of the light tight oil.

According to one or more embodiments, the light tight oil comprises at least 30% by weight of compounds having a boiling point below 300° C. relative to the total weight of the light tight oil.

According to one or more embodiments, the light tight oil comprises at least 50% by weight of compounds having a boiling point below 300° C. relative to the total weight of the light tight oil.

According to one or more embodiments, the operating conditions of the process are the following:

reactor outlet temperature: between 500° C. and 700° C.;

C/O ratio between 2 and 20.

According to one or more embodiments, the process uses at least one catalytic cracking catalyst comprising a matrix of alumina, of silica or of silica-alumina with a zeolite.

According to one or more embodiments, the catalyst comprises at least 15% by weight of Y zeolite relative to the total weight of the catalyst.

Embodiments according to the first aspect, together with other features and advantages of the processes according to the first aspect, will become apparent on reading the description which follows, given solely by way of illustration and without limitation, and with reference to the following drawings.

### BRIEF DESCRIPTION OF THE DRAWINGS

FIG. 1 represents a graph showing the change in the gasoline yield as a function of the content of light tight oil in the FCC feedstock (mixture with HDT VGO or ATR).

FIG. 2 represents a graph showing an optimum RON when the light tight oil content of the FCC feedstock is increased.

FIG. 3 represents the octane-barrel of the gasoline as a function of the light tight oil content of an FCC feedstock comprising hydrotreated vacuum gas oil.

FIG. 4 represents the octane-barrel of the gasoline as a function of the light tight oil content of an FCC feedstock comprising atmospheric residue.

FIG. 5 represents a graph showing that, although the conventional feedstock, the catalyst and the C/O used are modified, the octane-barrel may be increased as a function of the density resulting from the addition of the light tight oil in the FCC feedstock.

### DESCRIPTION OF THE EMBODIMENTS

The invention relates to an FCC process for an FCC feedstock comprising a light tight oil in co-treatment with a conventional FCC feedstock for the production of gasoline having a high yield and high octane number.

Specifically, it has been found that a feedstock of light tight oil type, for example an unfractionated and/or non-hydrotreated light tight oil (i.e., crude LTO), may be sent to an FCC process in co-treatment with a conventional FCC feedstock (e.g. VGO, ATR, VR, etc.), which is optionally hydrotreated, in order to produce gasoline having a high yield and high octane number.

The FCC process according to the invention may be defined as comprising the fluid catalytic cracking of an FCC feedstock comprising a light tight oil and at least one conventional feedstock in order to produce an effluent, the FCC feedstock having a content of light tight oil so that the density of the FCC feedstock is between 0.84 and 0.91, preferably between 0.860 and 0.892, very preferably between 0.866 and 0.886. The conventional feedstock may comprise at least one oil selected from the group consisting of a vacuum gas oil, an atmospheric residue, a coker gas oil (CGO), a vacuum residue and a recycle stream from a hydrocracking step.

According to one or more embodiments, the FCC process comprises the separation and the fractionation of the effluent in order to produce gasoline and optionally dry gas, LPG, LCO and/or a bottoms fraction.

According to one or more embodiments, the light tight oil comprises at least one of the following features:

density between 0.65 and 0.9, preferably between 0.7 and 0.9, very preferably between 0.70 and 0.85;

C5-220° C. content of greater than 15% by weight and preferably greater than 20% by weight relative to the total weight of the light tight oil;

sulfur content of less than 0.5% by weight relative to the total weight of the light tight oil;

metal (notably calcium, potassium, iron, etc.) content between 0 and 500 ppm relative to the total weight of the light tight oil.

According to one or more embodiments, the light tight oil comprises at least 30% by weight of compounds having a boiling point below 300° C., preferably at least 50% by weight relative to the total weight of the light tight oil.

It is understood in the present description that a product of an FCC process, such as an effluent of an FCC reactor, is not considered to be a conventional FCC feedstock.

According to one or more embodiments, the operating conditions of the FCC process are the following:

reactor outlet temperature (ROT): between 500° C. and 700° C., preferably between 500° C. and 600° C.;

C/O ratio (Catalyst to Oil ratio) between 2 and 20, preferably between 3 and 10.

According to one or more embodiments, the FCC process uses a catalyst comprising a matrix of alumina, of silica or of silica-alumina with a zeolite. The FCC catalyst may comprise at least 15% by weight of Y zeolite and optionally of ZSM-5 zeolite or other zeolite relative to the total weight of the catalyst.

The densities are measured by analysis with reference to NF EN ISO 12185, for example in the IFPEN (R05) petroleum analysis laboratory. For the mixtures, the densities are calculated from the densities of the pure feedstocks and as a function of the proportions of the mixture, such as for example: density of Fi+Fj mixture=1/(Fi %/Fi density+Fj %/Fj density) with Fj %=1−Fi %.

The invention will be better understood from reading the following examples.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding French application No. 18/71.365, filed Nov. 5, 2018, are incorporated by reference herein.

### EXAMPLES

Pilot tests were carried out on a small pilot plant (“short-contact-time resid test” or SCT-RT unit) in order to study the impact of the LTO content on the yields of the products at the outlet. The operating conditions applied for these tests are summarized in Table 1 below:

| | |
|---|---|
| Pressure (MPaA) | 0.15 |
| Operating mode | Adiabatic |
| C/O | 4-9 |
| Feedstock injection temperature (° C.) | 610 |
| Reactor head temperature (° C.) | 530 |
| Weight of feedstock injected (g) | 3 |

These operating conditions are specific to an SCT-RT unit and are equivalent to operating conditions of a standard FCC unit for a conversion of between 70% and 80% by weight. The conversion being defined according to the following formula: 100−(wt % LCO+wt % of the 360° C.⁺ fraction (i.e., “LCO %+SLURRY %”)). By way of example, the feedstock injection temperature of 610° C., used as parameter in SCT-RT, would correspond to an ROT in a standard FCC unit of between 500° C. and 590° C.

The properties of the light tight oil are described in Table 2 below.

| Properties | LTO |
|---|---|
| Density @ 15° C. | 0.7543 |
| Sulfur (% by weight) | 0.07 |
| Conradson carbon (% by weight) | 0.5 |
| Total nitrogen (ppm by weight) | 306 |
| Basic nitrogen (ppm by weight) | 111.9 |
| Ni (ppm by weight) | <2 |
| V (ppm by weight) | <2 |
| Carbon (% by weight) | 85.38 |
| Hydrogen (% by weight) | 14.62 |
| Aromatic carbon (%) | 9.09 |
| Paraffinic carbon (%) | 74.08 |
| Naphthenic carbon (%) | 16.83 |

This light tight oil was mixed with hydrotreated vacuum gas oil and atmospheric residue, the properties of which are described in Table 3 below.

| Properties | HDT VGO | ATR |
|---|---|---|
| Density @ 15° C. | 0.9018 | 0.9387 |
| Sulfur (% by weight) | 0.0612 | 0.5043 |
| Conradson carbon (% by weight) | <0.1 | 4.92 |
| Total nitrogen (ppm by weight) | 842 | 2125 |
| Basic nitrogen (ppm by weight) | 192 | 664.25 |
| Viscosity @ 100° C. (cSt) | 7.45 | 23.08 |
| Viscosity @ 70° C. (cSt) | 16.92 | 70.86 |
| Ni (ppm by weight) | <2 | 4.3 |
| V (ppm by weight) | <2 | 7.6 |
| C5 asphaltenes (% by weight) | 0.35 | |
| C7 asphaltenes (% by weight) | | 1.2 |
| Refractive index @ 70° C. | 1.4805 | 1.5005 |
| Carbon (% by weight) | 86.85 | 87.2 |
| Hydrogen (% by weight) | 12.79 | 12.11 |
| Aromatic carbon (% by weight) | 15.2 | 19.5 |
| Paraffinic carbon (% by weight) | 60.15 | 53.7 |
| Naphthenic carbon (% by weight) | 24.65 | 26.8 |
| SAR saturate (% by weight) | 52.4 | |
| SAR aromatic (% by weight) | 40.7 | |
| SAR resins (% by weight) | 6.9 | |

The tests were carried out with light tight oil contents ranging from 0 to 100% by weight, a C/O ratio of 4 and a different catalyst for each conventional feedstock, the main properties of which are summarized in Table 4 below.

| Properties | Catalyst 1 | Catalyst 2 |
|---|---|---|
| TSA (m²/g) | 345 | 380 |
| ZSA/MSA | 2.45 | 1.9 |
| REO (% by weight) | 0.9 | 2 |
| ZSM-5 (% by weight) | 0 | 0 |

TSA: total surface area
ZSA: zeolite surface area
MSA: matrix surface areas
REO: Rare-earth oxide

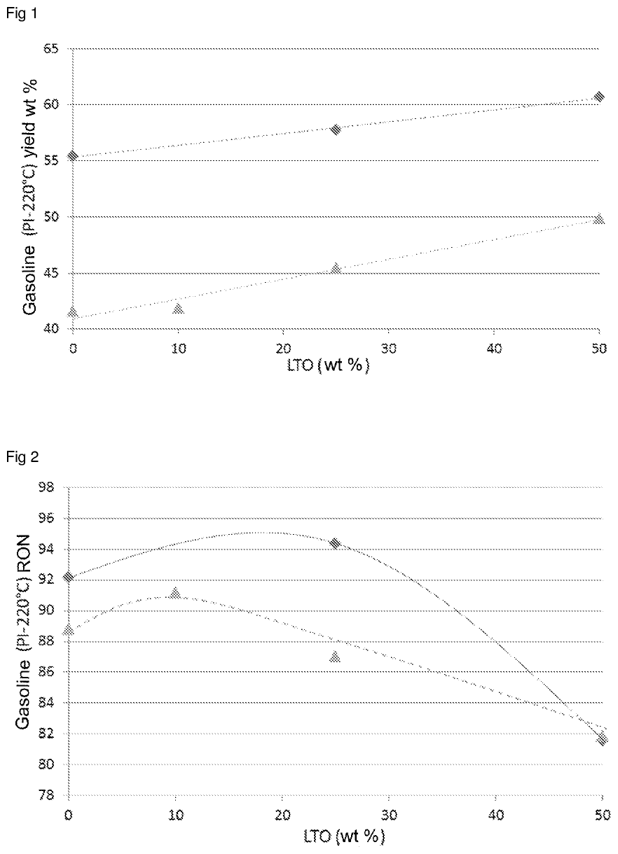

In FIGS. 1 to 4, the lozenges represent the results obtained with an FCC feedstock comprising light tight oil and hydrotreated vacuum gas oil in the presence of the catalyst 2 and with a C/O of 4; the triangles represent the results obtained with an FCC feedstock comprising light tight oil and atmospheric residue in the presence of the catalyst 1 and with a C/O of 4).

FIG. 1 represents a graph showing the change in the gasoline yield as a function of the light tight oil content in the feedstock. The gasoline yield increases with the light tight oil content since the naphtha fraction of the light tight oil is basically greater than that of a conventional FCC feedstock.

In these examples, the naphtha fraction of the light tight oil is paraffinic (see Table 2) and therefore has, by default, a rather low RON. As explained above, the increase in the gasoline yield comes partly from the naphtha fraction of the light tight oil which is not cracked or not very cracked, it could therefore be expected to have an RON that decreases with the light tight oil content of the mixture. On the contrary, it can be seen in FIG. 2 that there is an optimum RON when the light tight oil content of the mixture is increased, which lies between 10% and 25% in the case of the hydrotreated vacuum gas oil and around 10% in the case of the atmospheric residue.

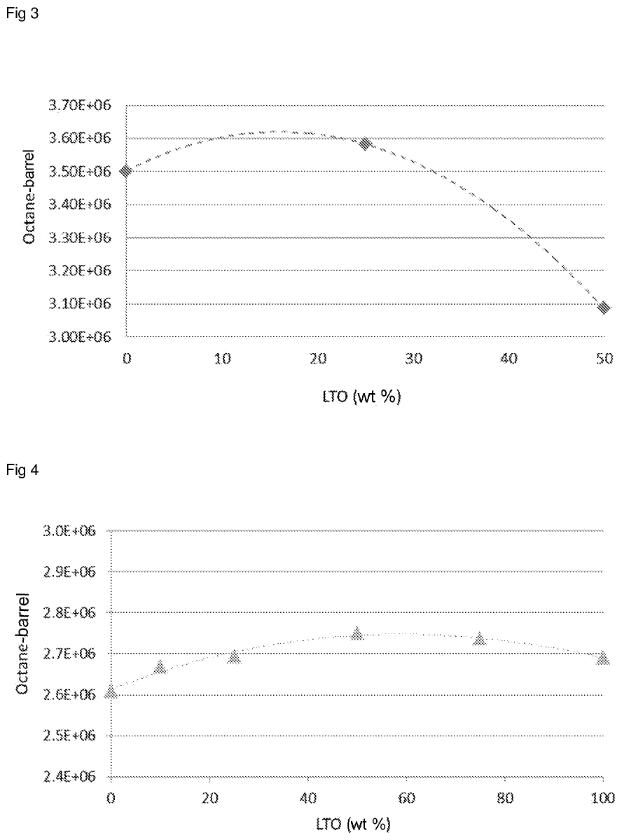

In order to increase the production of gasoline, it is possible to make a compromise between the yield obtained and the quality thereof (represented for the most part by its RON/MON). The term MON stands for motor octane number. This compromise may be expressed as octane-barrel (octane-barrel=gasoline yield (BPSD)×(RON+MON)/2). The term BPSD stands for barrels per stream day. FIGS. 3 and 4 represent the octane-barrel of the gasoline as a function of the light tight oil content of a feedstock comprising hydrotreated vacuum gas oil and atmospheric residue, respectively. In these examples, the optimum lies at around 15% by weight of light tight oil in the mixture for the hydrotreated vacuum gas oil and closer to 50% by weight of light tight oil in the mixture for the atmospheric residue.

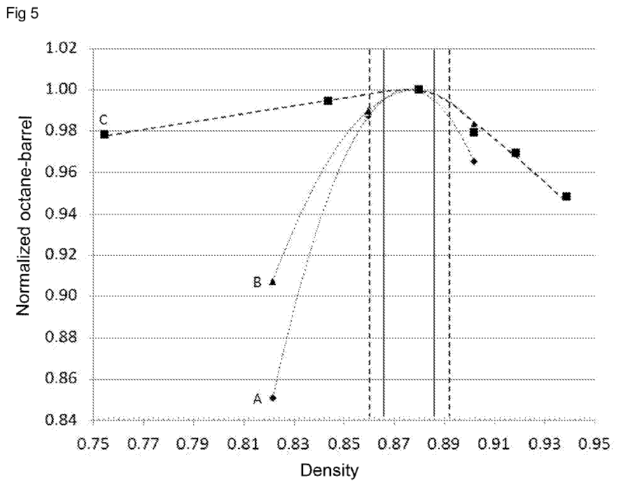

As shown in FIG. 5, it is possible to increase the octane-barrel by using an FCC feedstock having a content of light tight oil so that the density of the FCC feedstock is between 0.84 and 0.91, preferably between 0.860 and 0.892, very preferably between 0.866 and 0.886. Example A corresponds to an FCC process for a feedstock comprising hydrotreated vacuum gas oil and light tight oil with a C/O of 4 and the catalyst 1. Example B corresponds to an FCC process for a feedstock comprising hydrotreated vacuum gas oil and light tight oil with a C/O of 9 and the catalyst 1. Example C corresponds to an FCC process for a feedstock comprising atmospheric residue and light tight oil with a C/O of 4 and the catalyst 2. FIG. 5 clearly shows that, although the conventional feedstock, the catalyst and the C/O used are modified, the octane-barrel may be increased as a function of the density resulting from the mixing of the light tight oil with the conventional feedstock.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Process for fluid catalytic cracking of a feedstock comprising a light tight oil and at least one conventional feedstock in order to produce an effluent, in which the feedstock has a content of light tight oil so that the density of the feedstock is between 0.84 and 0.91.

2. Process according to claim 1, in which the conventional feedstock comprises an oil selected from the group consisting of a vacuum gas oil, an atmospheric residue, a coker gas oil, a vacuum residue and a recycle stream from a hydrocracking step.

3. Process according to claim 1, in which the feedstock has a content of light tight oil so that the density of the feedstock is between 0.860 and 0.892.

4. Process according to claim 1, in which the feedstock has a content of light tight oil so that the density of the feedstock is between 0.866 and 0.886.

5. Process according to claim 1, in which the light tight oil comprises at least one of the following features:
density between 0.65 and 0.9;
C5-220° C. content of greater than 15% by weight and preferably greater than 20% by weight;
sulfur content of less than 0.5% by weight;
metal content between 0 and 500 ppm.

6. Process according to claim 1, in which the light tight oil comprises at least 30% by weight of compounds having a boiling point below 300° C.

7. Process according to claim 1, in which the light tight oil comprises at least 50% by weight of compounds having a boiling point below 300° C.

8. Process according to claim 1, in which the operating conditions of the process are the following:
reactor outlet temperature: between 500° C. and 700° C.;
C/O ratio between 2 and 20.

9. Process according to claim 1, using at least one catalytic cracking catalyst comprising a matrix of alumina, of silica or of silica-alumina with a zeolite.

10. Process according to claim 9, in which the catalyst comprises at least 15% by weight of Y zeolite.
